(19) United States
(12) Patent Application Publication
(10) Pub. No.: US 2011/0103474 A1
(43) Pub. Date: May 5, 2011

(54) APPARATUS FOR TRANSFORMING MEDIUM GRAINED SCALABILITY-BASED SCALABLE VIDEO CODING BITSTREAM INTO ADVANCED VIDEO CODING BITSTREAM

(75) Inventors: Truong Cong Thang, Daejeon (KR); Jung Won Kang, Daejeon (KR); Jeong Ju Yoo, Daejeon (KR); Jin Woo Hong, Daejeon (KR)

(73) Assignee: ELECTRONICS AND TELECOMMUNICATIONS RESEARCH INSTITUTE, DAEJEON (KR)

(21) Appl. No.: 13/000,855

(22) PCT Filed: Jul. 16, 2009
(86) PCT No.: PCT/KR2009/003908

§ 371 Date: Dec. 22, 2010

(30) Foreign Application Priority Data
Jul. 16, 2008 (KR) 10-2008-0068860
Jul. 8, 2009 (KR) 10-2009-0062074

(51) Int. Cl. H04N 7/12

(52) U.S. Cl. 375/240.12; 375/E07.243

(57) ABSTRACT

A Medium Grained Scalability (MGS)-to-Advanced Video Coding (AVC) transform apparatus may modify an accumulated residual signal of at least one MGS layer of a key picture, included in an MGS-based Scalable Video Coding (SVC) bitstream, and rewrite the MGS-based SVC bitstream into an AVC bitstream.

### TECHNICAL FIELD

The present invention relates to a method to transform or rewrite a Medium Grained Scalability (MGS)-based Scalable Video Coding (SVC) bitstream into an Advanced Video Coding (AVC) bitstream.

### BACKGROUND ART

Scalable Video Coding (SVC) is a promising video format for applications of multimedia communication. An SVC format, which is extended from Advanced Video Coding (AVC), is appropriate to create a wide variety of bit rates having high compression efficiency.

An SVC bitstream may be easily truncated in different manners to meet various characteristics and variations of devices and connections.

For this, the scalability may be possible in three dimensions: spatial, temporal, and Signal to Noise Ratio (SNR).

Normatively, the quality/SNR scalability may have two modes, a Coarse Grained Scalability (CGS) scheme and a Medium Grained Scalability (MGS) scheme.

Like the AVC format, an SVC bitstream may be divided into Network Abstraction Layer (NAL) units. SVC NAL units may be attributed by some basic elements including dependency_id, quality_id, temporal_id, and priority_id which are respectively the identifiers of a spatial layer, a quality layer, a temporal layer, and a priority layer.

To accommodate a large number of existing AVC-conforming terminals, a current SVC specification may support fast rewriting of a CGS-based SVC bitstream into an AVC bitstream.

The current SVC specification may basically accumulate residual signals of multiple CGS layers into a single layer while retaining all information about motion information, macroblock partitioning, and prediction modes.

This rewriting process may be very fast since it is done in transform domain and no prediction loop is required. The feature may be referred to as ‘CGS-to-AVC rewriting’.

In SVC, an MGS mode is expected to be of high interest due to the feature of packet-based scalability. However, an SVC bitstream with an MGS enhancement layer may not be straightforwardly rewritten into an AVC bitstream as an SVC bitstream with a CGS enhancement layer.

Accordingly, a method to transform or rewrite an MGS-based SVC bitstream into an AVC bitstream is required.

### DISCLOSURE OF INVENTION

### Technical Goals

An aspect of the present invention provides a method to transform a Medium Grained Scalability (MGS)-based Scalable Video Coding (SVC) bitstream into an Advanced Video Coding (AVC) bitstream.

### Technical Solutions

According to an aspect of the present invention, there is provided an Advanced Video Coding (AVC) transform apparatus which transforms a Medium Grained Scalability (MGS)-based Scalable Video Coding (SVC) bitstream into an AVC bitstream, the AVC transform apparatus including: a discarding unit to discard an MGS layer of a key picture included in the MGS-based SVC bitstream; and a rewriting unit to rewrite the discarded MGS layer and a quality base layer into a single AVC access unit.

According to another aspect of the present invention, there is provided an AVC transform apparatus which transforms an MGS-based SVC bitstream into an AVC bitstream, the AVC transform apparatus including: a rewriting unit to modify an accumulated residual signal of at least one MGS layer of a key picture, included in the MGS-based SVC bitstream, and to rewrite the MGS-based SVC bitstream into the AVC bitstream.

### Advantageous Effects

According to an embodiment of the present invention, there is provided a method to transform a Medium Grained Scalability (MGS)-based Scalable Video Coding (SVC) bitstream into an Advanced Video Coding (AVC) bitstream.

### BRIEF DESCRIPTION OF DRAWINGS

FIG. 1 is a diagram illustrating inter-prediction in a Medium Grained Scalability (MGS) scheme and an Advanced Video Coding (AVC) scheme;

FIG. 2 is a block diagram illustrating an AVC transform apparatus according to an embodiment of the present invention;

FIG. 3 is a block diagram illustrating a Drift-Compensating Data (DCD) generator according to an embodiment of the present invention;

FIG. 4 is a block diagram illustrating a DCD generator according to another embodiment of the present invention;

FIG. 5 is a block diagram illustrating a DCD generator according to still another embodiment of the present invention;

FIG. 6 is a diagram illustrating an MGS-to-AVC rewriting according to an embodiment of the present invention;

FIG. 7 is a block diagram illustrating a configuration of an AVC transform apparatus according to an embodiment of the present invention; and

FIG. 8 is a block diagram illustrating an AVC transform apparatus according to another embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

The coding mechanism of Medium Grained Scalability (MGS) is nearly the same as a coding mechanism of Coarse Grained Scalability (CGS). The main differences between CGS and MGS is the high level syntax and the concept of key picture.

The high level syntax allows the flexibility in discarding data to meet a bitrate constraint, while the key picture allows controlling a drift caused by discarding MGS Network Abstraction Layer (NAL) units.

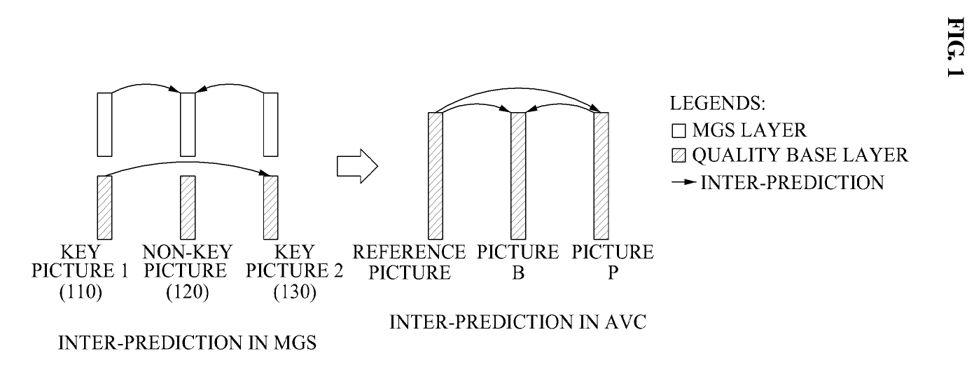

FIG. 1 is a diagram illustrating inter-prediction in the MGS scheme and the Advanced Video Coding (AVC) scheme.

For convenience of description, a single non-key picture 120 is illustrated in FIG. 1.

As shown in FIG. 1, motion compensation for a key picture (2) 130 is done using base layer representation of a previous key picture, that is, a key picture (1) 110.

Conversely, inter-prediction for a non-key picture 120 is done using the highest layer representations of pictures that belong to lower temporal layers.

When a quality base layer and MGS layers are combined into a single layer, the quality of reference picture used for the non-key picture 120 is unchanged.

This may indicate that an MGS-to-AVC rewriting of the non-key picture 120 may be done in a same manner as a Coarse Grained Scalability (CGS)-to-AVC rewriting. Here, the ‘MGS-to-AVC rewriting’ indicates an operation of rewriting an MGS-based Scalable Video Coding (SVC) bitstream into an AVC bitstream, and the ‘CGS-to-AVC rewriting’ indicates an operation of rewriting a CGS-based SVC bitstream into an AVC bitstream.

However, when the quality base layer and the MGS layers are combined into a single layer, the reference picture, that is, the key picture (1) 110, which is used for inter-prediction of a following key picture, that is, the key picture (2) 130, may have higher quality in comparison with the original quality base layer of the key picture (1) 110. The key picture (1) 110 may be used to predict the key picture (2) 130 when encoding the key picture (2) 130.

That is, when the quality base layer and the MGS layers are combined into the single layer, a mismatch may occur between an MGS layer of the key picture (1) 110 and an MGS layer of the key picture (2) 130, when predicting the key picture (2) 130.

Accordingly, the quality of the key picture (2) 130 predicted from the key picture (1) 110 may be degraded, and the quality of a following key picture predicted from the key picture (2) 130 may be degraded. That is, the mismatch may result in a drift effect which may gradually degrade all following key pictures, and consequently all the dependent non-key pictures.

Thus, a method that may prevent the mismatch of the MGS layers at key pictures during the MGS-to-AVC rewriting is required.

According to the present invention, exemplary embodiments are provided to prevent the mismatch caused by MGS layers at key pictures during the MGS-to-AVC rewriting.

### <An Exemplary Embodiment to Discard an MGS Layers>

According to the exemplary embodiment, a method of discarding all MGS layers at key pictures before an access unit of an SVC key picture is rewritten into an AVC access unit during the MGS-to-AVC rewriting is provided.

That is, all the MGS layers at key pictures may be discarded before rewriting, and thus a mismatch caused by the MGS layers at key pictures may be prevented.

In this instance, after discarding all the MGS layers at key pictures, the MGS-to-AVC rewriting may be performed by applying a CGS-to-AVC rewriting as usual.

However, since the MGS layers at key pictures are discarded, quality of the key pictures may be degraded. Also, since MGS data of the key pictures may be used for inter-prediction of non-key pictures, quality of the non-key pictures may be degraded.

Accordingly, another exemplary embodiment to perform the MGS-to-AVC rewriting without discarding the MGS layer of the key pictures is provided.

### <An Exemplary Embodiment to Modify an MGS Layers>

### 1. General Architecture

According to the exemplary embodiment, a method of preventing a mismatch at key pictures while maintaining a high quality of key pictures is provided, different from the exemplary embodiment of discarding MGS layers.

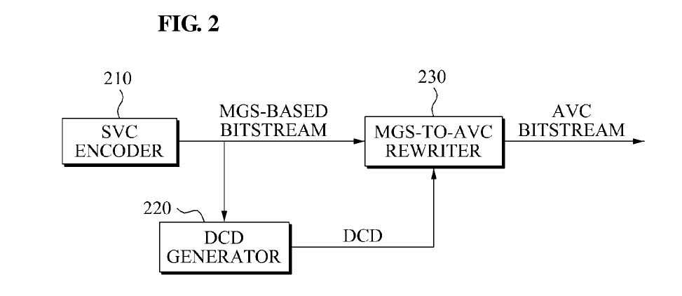

FIG. 2 is a block diagram illustrating an AVC transform apparatus according to an embodiment of the present invention.

An MGS-based SVC bitstream provided by an SVC encoder 210 may be sent to a Drift-Compensating Data (DCD) generator 220.

When a key picture is predicted from a previous key picture, the key picture may be associated with some supplementary data used to compensate for the mismatch caused by MGS layers of the previous key picture.

In this instance, the supplementary data is called DCD.

The DCD generator 220 may generate DCD based on the MGS-based SVC bitstream provided by the SVC encoder 210.

An MGS-to-AVC rewriter 230 may modify an accumulated residual signal of at least one MGS layer of a key picture using the DCD. The key picture may be included in the MGS-based SVC bitstream. That is, MGS-to-AVC rewriting may be performed.

In this instance, the modification of the residual signal is applied to inter-coded blocks of key pictures. Also, the DCD is not employed by a decoding process.

According to the exemplary embodiment, the DCD generator 220 may be a stand-alone type, separate from the AVC transform apparatus, may be included in the SVC encoder 210, or may be included in the MGS-to-AVC rewriter 230.

The AVC transform apparatus has been described with reference to FIG. 2. Detailed operations of the DCD generator 220 are described below, before detailed operations of the AVC transform apparatus are described.

### 2. Generation of DCD

Residual signals from multiple layers may be accumulated either in a transform coefficient domain or in a transform coefficient level domain.

A difference between the transform coefficient domain and the transform coefficient level domain is that transform coefficient levels may be obtained by quantizing transform coefficient values.

Accordingly, combining the residual signals in the transform coefficient domain may require an inverse quantization of the transform coefficient levels. Also, combining the residual signals in the transform coefficient level domain does not require the inverse quantization.

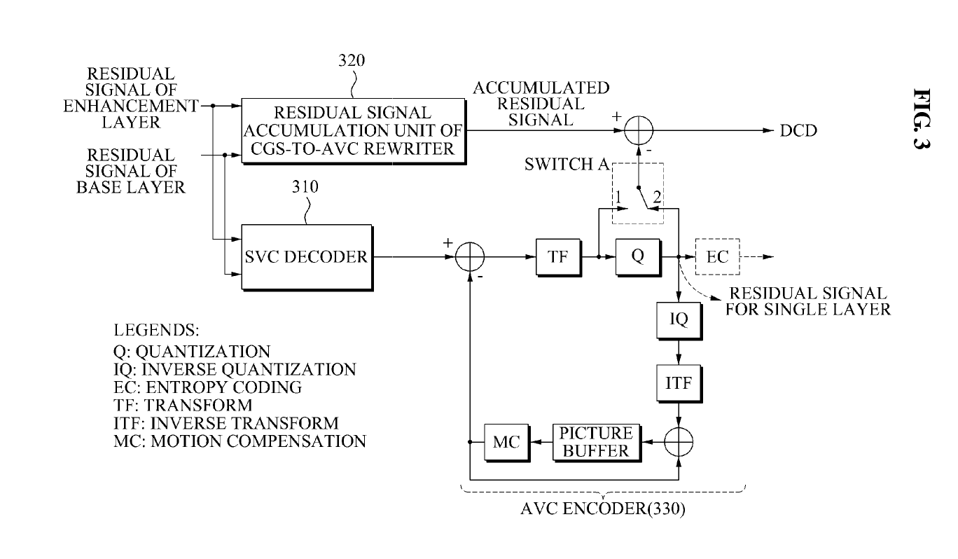

The generation of DCD may be accomplished in different ways. As shown in FIG. 3, the most straightforward way may be comparing an accumulated residual signal, provided by a CGS-to-AVC rewriter, with a correct residual signal provided by an AVC encoder 330.

FIG. 3 is a block diagram illustrating a DCD generator according to an embodiment of the present invention.

An SVC decoder 310 may obtain correct pixel values from residual signal of a base layer and residual signal of an enhancement layer. Here, the correct pixel values are to be sent to the AVC encoder 330.

The AVC encoder 330 may receive the residual signal from the SVC decoder 310, and provide a residual signal. In this instance, the residual signal generated by the AVC encoder 330 is the residual signal correctly provided by the MGS-to-AVC rewriter 230 for the MGS-to-AVC rewriting process.

Here, combining of the SVC decoder 310 and the AVC encoder 330 may be similar to the well-known architecture of a cascaded transcoder.

When located in a position 1, the switch A provides the correct residual signal as transform coefficient values. When located in a position 2, the switch A provides the correct residual signal as transform coefficient levels.

A residual signal accumulation unit 320 of the CGS-to-AVC rewriter may generate the accumulated residual signal from the residual signal of the base layer and the residual signal of the enhancement layer.

In this instance, the DCD may be obtained as the difference between the residual signal, provided by the residual signal accumulation unit 320 of the CGS-to-SVC rewriter, and the correct residual signal provided by the AVC encoder 330.

When the DCD is computed in advance and sent to the MGS-to-AVC rewriter 230, the correct residual signal, which is to be generated by the MGS-to-AVC rewriter 230, can be obtained by subtracting the DCD from the residual signal provided by the residual signal accumulation unit 320 of the CGS-to-AVC rewriter.

In this instance, the AVC encoder 330 may reuse motion information, block modes/partitions, and quantization parameters from a highest layer of the MGS-based bitstream.

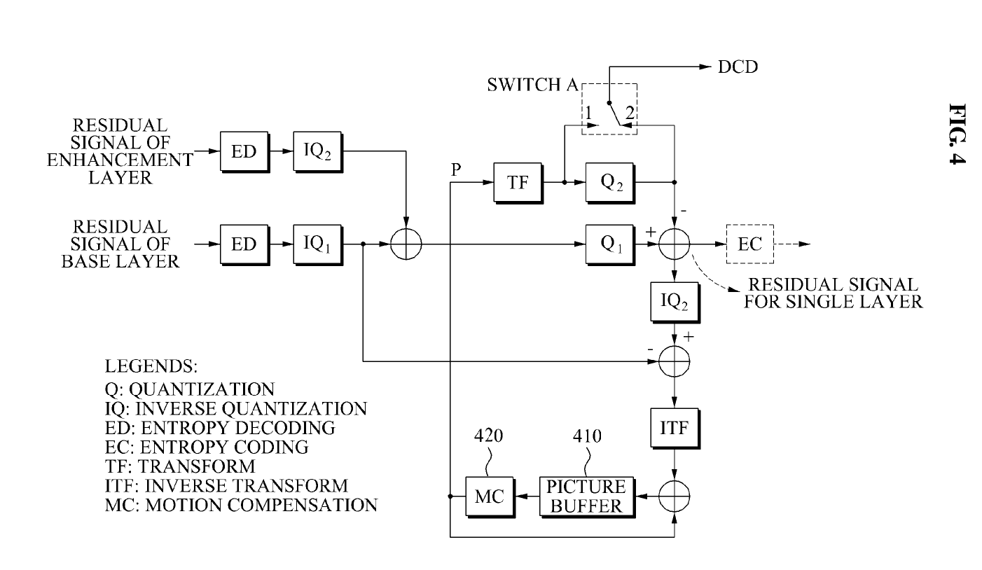

FIG. 4 is a block diagram illustrating a DCD generator according to another embodiment of the present invention.

FIG. 4 illustrates a faster method to generate DCD, and the faster method may be based on the closed-loop transcoding architecture.

Q₁ and Q₂ may denote a quantization operation of each of the base layer and the enhancement layer in FIG. 4.

In the method, a difference of base quality representation and highest quality representation of a previous key picture may be decoded, and the difference picture may be stored in a picture buffer 410.

In this instance, a motion-compensated version P of the difference picture is required to be eliminated or compensated at a current key picture.

Accordingly, transform and quantization may be applied to the motion-compensated version P to obtain the DCD.

In this instance, the usage of the switch A may be the same as that in FIG. 3.

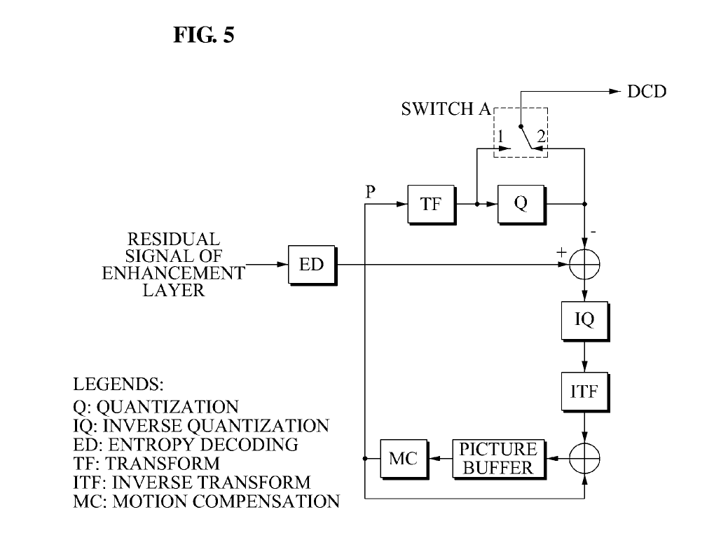

Since the block diagram in FIG. 4 may be for obtaining the DCD, as opposed to obtaining transcoded pictures in AVC format, the DCD generator in FIG. 4 may be simplified to perform motion compensation by decoding only the residual signal of the enhancement layer, as illustrated in FIG. 5.

The quantization parameter used in quantization and inverse quantization is the quantization parameter of the enhancement layer.

When the previous key picture has at least one MGS layer, the DCD may be sequentially obtained for each of the MGS layers.

Denote DCD_{j˜i} as DCD corresponding to enhancement data that covers from an MGS layer j to MGS layer i (j≦i), and DCDᵢ as DCD corresponding to the MGS layer i. DCD_{j˜i} may be computed by:

DCD_{j˜i}=DCD_{1˜i}−DCD_{1˜j} [Equation 1]

where DCDᵢ may denote DCD corresponding to the MGS layer i, and may be identical to DCD_{i˜i}.

In a current SVC specification, residual signal accumulation in a key picture may not be done in a transform coefficient level domain. Accordingly, to enable the MGS-to-AVC rewriting in the transform coefficient level domain, a syntax element tcoeff_level_prediction_flag may be a value of 1 in the key picture.

With respect to the SVC encoder 210, it is well known that a virtual decoder is included in an encoding process, and the residual signal of the base layer and the residual signal of the enhancement layer are always available in a spatial domain or a transform domain.

Accordingly, the methods for DCD generation, described with reference to FIG. 3 through FIG. 5, may be easily integrated into the SVC encoder 210.

DCD may be obtained offline either by the standalone DCD generator 220 or by the SVC encoder 210. In this case, a predetermined storage format is required to store the DCD, which will be described below.

Also, DCD may be obtained online at the MGS-to-AVC rewriter, and thus DCD storage may be unnecessary.

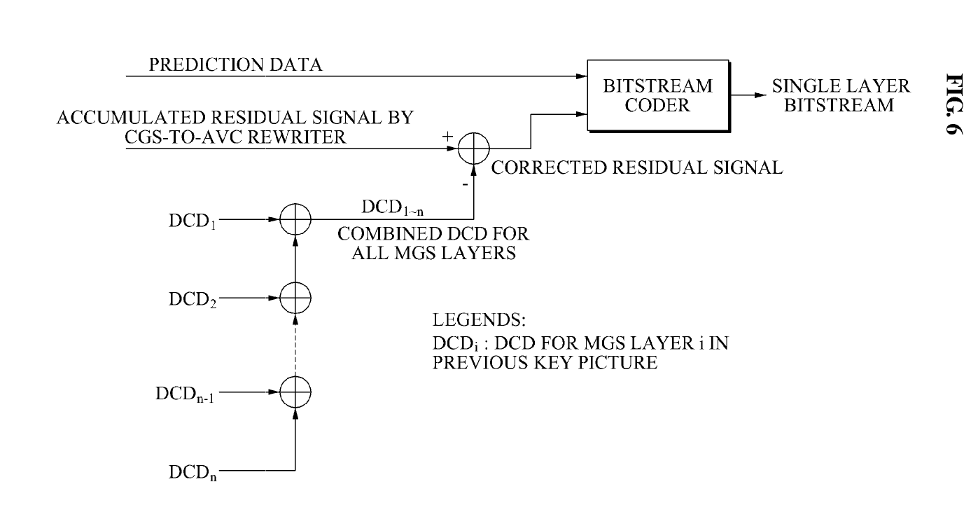

The generation of DCD has been described in detail. Hereinafter, the MGS-to-AVC rewriting based on the generated DCD is described with reference to FIG. 6.

### 3. MGS-to-AVC Rewriting

FIG. 6 is a diagram illustrating MGS-to-AVC rewriting according to an embodiment of the present invention.

The MGS-to-AVC rewriting shown in FIG. 6 is similar to a CGS-to-AVC rewriting. However, the MGS-to-AVC rewriting is different from the CGS-to-AVC rewriting in that an accumulated residual signal of a CGS-to-AVC rewriter is modified by DCD.

It may be assumed that a previous key picture has n MGS layers corresponding to DCD_{1˜n}.

When a set of {DCDᵢ} is already available, DCD_{1˜n} may be computed by,

DCD_{1˜n}=DCD₁+DCD₂+ . . . +DCDₙ [Equation 2]

When the set of {DCDᵢ} is not available, DCD_{1˜n} may be obtained online.

When the DCD is obtained, the accumulated residual provided by the CGS-to-AVC rewriter may be subtracted by DCD_{1˜n} to compensate for presence of the n MGS layers in the previous key picture.

Subsequently, the corrected residual signal and prediction data including motion information, block partitions, prediction modes, and the like, may be inputted into the bitstream coder.

In this instance, the bitstream coder may generate a single layer bitstream based on the corrected residual signal and the prediction data.

When the DCD is obtained in the transform coefficient level domain, and the accumulated residual signal, provided by the CGS-to-AVC rewriter, is in the transform coefficient domain, the DCD may be inverse-quantized before being used in obtaining the modified residual signal.

Also, when the DCD and the accumulated residual signal provided by the CGS-to-AVC rewriter are in the transform coefficient level domain, and have different quantization parameters, the DCD and the accumulated residual signal are to be inverse-quantized before subtracting.

That is, the DCD and the accumulated residual signal of the CGS-to-AVC rewriter are required to correspond to a same quantization parameter.

### 4. Storage of DCD

When DCD for key pictures of an MGS-based bitstream is generated in advance, the DCD may be stored in different ways.

An SVC syntax may be reused to represent the DCD. Specifically, each DCDᵢ may be stored in one Supplemental Enhancement Information (SEI) message that contains a syntax of slice_data_in_scalable_extension( ). In this instance, a syntax of an MGS rewriting SEI message may be as shown in Table 1.

TABLE 1

| MGS_Rewriting( payload ) { | C | Descriptor |
|---|---|---|
| dependency_idx | 5 | u(3) |
| mgs_layer_idx | 5 | u(4) |
| num_covered_mgs_layer_minus1 | 5 | ue(v) |
| slice_data_in_scalable_extension( ) | | |
| } | | |

Hereinafter, the semantics of the MGS rewriting SEI message are described.

The MGS rewriting SEI message may be applied to only a key access unit. The MGS rewriting SEI message may include data used to compensate for a drift at a current key picture, when multiple MGS layer representations of a previous key picture, referenced by current key picture, are combined into a single layer.
dependency_idx: indicates dependency_id of a dependency layer in the previous key picture
mgs_layer_idx: indicates quality_id of an MGS layer in the previous key picture
num_covered_mgs_layer_minus1: num_covered_mgs_layer_minus1+1 indicates a number of adjacent MGS layers (with mgs_layer_idx being a highest quality_id), for which DCD are conveyed by the current MGS rewriting SEI message.

The following changes may be applied to slice_data_in_scalable_extension( )
Only inter-coded macroblocks may be encoded, all the other macroblocks are skipped.
default_base_mode_flag of this syntax is equal to 1, or base_mode_flag of each encoded macroblock is equal to 1.
No motion information is included for inter-coded macroblocks.
Both adaptive_residual_prediction_flag and default_residual_prediction_flag are to be equal to 0.
For an encoded block, transform_size_{—}8×8_flag is identical to that of a collocated block in primary coded slices of the current key picture.
Semantics of mb_qp_delta may be changed as follows: when mb_qp_delta=0, variable level[ ][ ] in residual signal (bmFlag, startIdx, endIdx) may represent a transform coefficient value; when mb_qp_delta=1, variable level[ ][ ] in residual signal (bmFlag, startIdx, endIdx) may represent a transform coefficient level and a quantization parameter may be the same as that of an MGS layer with quality_id equal to mgs_layer_idx of the previous key picture. Another solution for the new semantics of mb_qp_delta is that it directly represent the quantization parameter of the corresponding DCD.

When storing each DCD₁ in an individual SEI message, only necessary DCDᵢ's are sent and parsed to obtain the total DCD. For example, although the previous key picture may originally have five MGS layer representations, when only two MGS layer representations remain at the time of rewriting, only two MGS rewriting SEI messages, corresponding to DCD₁ and DCD₂, may be used for drift compensation.

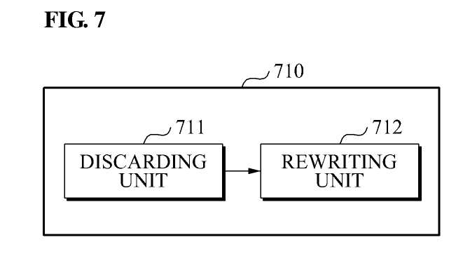

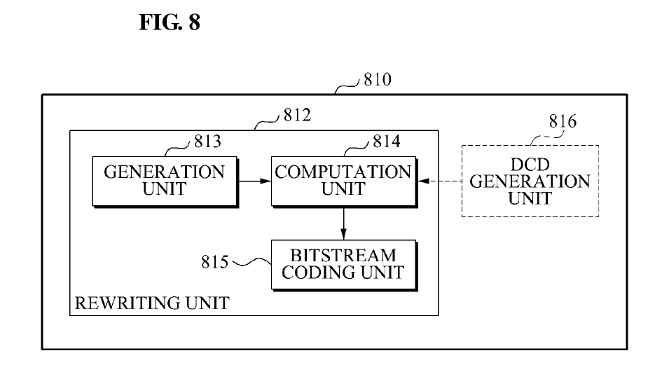

Exemplary embodiments for MGS-to-AVC rewriting have been described with reference to FIG. 1 through FIG. 6. Hereinafter, exemplary embodiments associated with an AVC transform apparatus are described with reference to FIG. 7 and FIG. 8.

FIG. 7 is a block diagram illustrating a configuration of an AVC transform apparatus 710 according to an embodiment of the present invention.

Referring to FIG. 7, the AVC transform apparatus 710 may include a discarding unit 711 and a rewriting unit 712.

The discarding unit 711 may discard MGS layers of a key picture included in an MGS-based SVC bitstream.

The rewriting unit 712 may rewrite the discarded MGS layer and quality base layer into a single AVC access unit.

The AVC transform apparatus 710 may correspond to the exemplary embodiment to discard MGS layers described above, and thus detailed description may be omitted herein.

FIG. 8 is a block diagram illustrating an AVC transform apparatus 810 according to another embodiment of the present invention.

Referring to FIG. 8, the AVC transform apparatus 810 may include a rewriting unit 812.

The rewriting unit 812 may modify an accumulated residual signal of at least one MGS layer of a key picture, and rewrite an MGS-based SVC bitstream into an AVC bitstream. The key picture may be included in the MGS-based SVC bitstream.

The rewriting unit 812 may include a generation unit 813, a computation unit 814, and a bitstream coding unit 815.

The generation unit 813 may generate the accumulated residual signal of the at least one MGS layer of the key picture using a CGS-to-AVC rewriter that rewrites a CGS-based SVC bitstream into the AVC bitstream.

The computation unit 814 may compute a modified residual signal of the key picture based on a difference between the accumulated residual signal and DCD.

Here, the DCD may be supplementary data used to compensate for prediction mismatch of the key picture, when the key picture is predicted from a previous key picture. The prediction mismatch may occur by an MGS layer of the previous key picture.

The bitstream coding unit 815 may generate a single layer bitstream based on the modified residual signal and prediction data. The prediction data may be used to predict the key picture from the previous key picture.

The DCD may be any one of a transform coefficient domain and a transform coefficient level domain.

Also, the DCD and the accumulated residual signal may be scaled to correspond to a same quantization coefficient. The accumulated residual signal of the at least one MGS layer of the key picture may be generated using the CGS-to-AVC rewriter.

Also, the DCD may be stored in an SEI message.

In this instance, the SEI message may be defined in the syntax of Table 1.

The AVC transform apparatus 810 may further include a DCD generation unit 816 to generate the DCD.

In this instance, the DCD generation unit 816 may include an SVC decoding unit, an AVC encoding unit, a second residual signal generation unit, and a DCD computation unit, which are not illustrated in FIG. 8.

The SVC decoding unit may decode the MGS-based SVC bitstream and obtain pixel values.

The AVC encoding unit may receive the pixel values from the SVC decoding unit and generate a first residual signal.

The second residual signal generation unit may generate an accumulated second residual signal of the at least one MGS layer of the key picture using the CGS-to-AVC rewriter.

The DCD computation unit may compute the DCD using a difference between the second residual signal and the first residual signal.

The AVC transform apparatus 810 may correspond to the exemplary embodiment to modify an MGS layer described above, and thus detailed description may be omitted herein.

The exemplary embodiments of the present invention include computer-readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A Advanced Video Coding (AVC) transform apparatus which transforms a Medium Grained Scalability (MGS)-based Scalable Video Coding (SVC) bitstream into an AVC bitstream, the AVC transform apparatus comprising:
a discarding unit to discard MGS layers of a key picture included in the MGS-based SVC bitstream; and
a rewriting unit to rewrite the discarded MGS layers and a quality base layer into a single AVC access unit.

2. An AVC transform apparatus which transforms an MGS-based SVC bitstream into an AVC bitstream, the AVC transform apparatus comprising:
a rewriting unit to modify an accumulated residual signal of a key picture, and to rewrite the MGS-based SVC bitstream into the AVC bitstream, the key picture being included in the MGS-based SVC bitstream.

3. The AVC transform apparatus of claim 2, wherein the rewriting unit comprises:
a generation unit to generate the accumulated residual signal of the key picture using a Coarse Grained Scalability (CGS)-to-AVC rewriter that rewrites a CGS-based SVC bitstream into the AVC bitstream;
a computation unit to compute a modified residual signal of the key picture based on a difference between the accumulated residual signal and Drift-Compensating Data (DCD); and
a bitstream coding unit to generate a single layer bitstream based on the modified residual signal and prediction data, the prediction data being used to predict the key picture from a previous key picture,
wherein the DCD is supplementary data used to compensate for a prediction mismatch of the key picture, when the key picture is predicted from the previous key picture, the prediction mismatch being generated by an MGS layer of the previous key picture.

4. The AVC transform apparatus of claim 3, further comprising:
a DCD generation unit to generate the DCD.

5. The AVC transform apparatus of claim 4, wherein the DCD generation unit comprises:
an SVC decoding unit to decode the MGS-based SVC bitstream and to obtain pixel value;
an AVC encoding unit to receive the pixel value from the SVC decoding unit and to generate a first residual signal;
a second residual signal generation unit to generate an accumulated second residual signal of the at least one MGS layer of the key picture using the CGS-to-AVC rewriter; and
a DCD computation unit to compute the DCD using a difference between the second residual signal and the first residual signal.

6. The AVC transform apparatus of claim 3, wherein the DCD is any one of a transform coefficient domain and a transform coefficient level domain.

7. The AVC transform apparatus of claim 3, wherein the DCD and the accumulated residual signal are scaled to correspond to a same quantization coefficient, the accumulated residual signal of the at least one MGS layer of the key picture being generated using the CGS-to-AVC rewriter.

8. The AVC transform apparatus of claim 3, wherein the DCD is stored in a Supplemental Enhancement Information (SEI) message.

9. The AVC transform apparatus of claim 8, wherein the SEI message is defined as a syntax shown in below.

| MGS_Rewriting( payload ) { | C | Descriptor |
|---|---|---|
| dependency_idx | 5 | u(3) |
| mgs_layer_idx | 5 | u(4) |
| num_covered_mgs_layer_minus1 | 5 | ue(v) |
| slice_data_in_scalable_extension( ) | | |
| } | | |
